(19) United States
(12) Patent Application Publication
(10) Pub. No.: US 2009/0222370 A1
(43) Pub. Date: Sep. 3, 2009

(54) METHOD AND SYSTEM FOR EXCHANGING FINANCIAL-TRANSACTION-RELATED MESSAGES OVER A COMMUNICATIONS NETWORK

(75) Inventor: Stan J. DEUDNEY, Uxbridge (CA)

Correspondence Address: SMART & BIGGAR, 1000 DE LA GAUCHETIERE ST. W., SUITE 3300, MONTREAL, QC, H3B 4W5, CA

(73) Assignee: BELL CAPITAL MARKET SOLUTIONS INC.

(21) Appl. No.: 12/463,630

(22) Filed: May 11, 2009

Related U.S. Application Data
(63) Continuation of application No. 11/615,192, filed on Dec. 22, 2006.

(51) Int. Cl. G06Q 40/00

(52) U.S. Cl. 705/35

(57) ABSTRACT

At a first functional entity, a financial-transaction-related message destined for a destination associated with a second functional entity is received. The financial-transaction-related message is assessed for compliance with a fundamental message format and, upon assessing that the financial-transaction-related message is not compliant with the fundamental message format, a translation of said financial-transaction-related message into a translated message that is compliant with the fundamental message format is effected and the translated message is released towards said destination. The translated message is then received at the second functional entity, and the translated message is assessed for compliance with a message format that is employed by the destination. Upon assessing that the translated message is not compliant with a message format that is employed by the destination, the translated message is translated into a re-translated message that is compliant with a message format that is employed by the destination.

### FIELD OF THE INVENTION

The present invention relates generally to the exchange of electronic messages over a network and, in particular, to the exchange of financial-transaction-related messages between parties to a financial transaction.

### BACKGROUND

Institutional buyers and sellers need to have reliable communication means to facilitate efficient trading in securities and other financial instruments. Traditionally, these parties have relied on telephone and fax communications to exchange orders, fills and other information (such as allocation information for bulk/block orders). Such methods have proven unreliable and susceptible to errors, e.g., as a result of transcribing information or transmitting information via voice communication means.

The adoption of FIX (Financial Information eXchange) as a protocol for electronically exchanging financial-transaction-related messages has the potential to bring a certain degree of efficiency to the trading process. The typical scenario where FIX has been used involves two parties to a financial transaction setting up a point-to-point communications link in order to exchange FIX protocol messages. However, this approach leads to two problems. The first problem is due to the establishment of numerous point-to-point communications links between the various members of the financial trading community, which can lead to an intractable mesh of communication links and nodes. The second problem is due to the evolution of the FIX protocol itself, which has resulted in the creation of numerous variants that are only loosely related to one another.

As a result, members of the financial trading community find themselves not only having to support a myriad of point-to-point communication links, but also having to support numerous protocol variants on such links. Consequently, any efficiency gains arising from the ability to exchange financial-transaction-related messages electronically can quickly become eroded by the complexity of the requisite supporting IT infrastructure.

Against this background, it is clear that an improvement is needed to the manner in which financial-transaction-related messages are communicated between parties to a financial transaction.

### SUMMARY OF THE INVENTION

According to a first broad aspect, the present invention seeks to provide a method for electronic communication of financial-transaction-related messages in a financial network architecture, comprising: at a first functional entity: receiving a financial-transaction-related message destined for a destination associated with a second functional entity; assessing whether said financial-transaction-related message is compliant with a fundamental message format and, upon assessing that said financial-transaction-related message is not compliant with the fundamental message format, effecting a translation of said financial-transaction-related message into a translated message that is compliant with the fundamental message format and releasing said translated message towards said destination. The method further comprises receiving the translated message at the second functional entity, assessing whether said translated message is compliant with a message format that is employed by the destination and, upon assessing that said translated message is not compliant with a message format that is employed by the destination, effecting a translation of said translated message into a re-translated message that is compliant with a message format that is employed by the destination.

According to a second broad aspect, the present invention seeks to provide an architecture for electronic communication of financial-transaction-related messages, comprising a first financial management system configured to receive a financial-transaction-related message destined for a destination associated with a second financial management system, said first financial management system being further configured to assess whether said financial-transaction-related message is compliant with a fundamental message format and, upon assessing that said financial-transaction-related message is not compliant with the fundamental message format, to effect a translation of said financial-transaction-related message into a translated message that is compliant with the fundamental message format, said first financial management system further configured to release said translated message. The architecture also comprises a hub configured to route said translated message from said first financial management system to said second financial management system. In addition, the second financial management system is configured to receive the translated message at the second financial management system, to assess whether said translated message is compliant with a message format that is employed by the destination and, upon assessing that said translated message is not compliant with a message format that is employed by the destination, to effect a translation of said translated message into a re-translated message that is compliant with a message format that is employed by the destination.

According to a third broad aspect, the present invention seeks to provide a method for electronic communication of financial-transaction-related messages in a financial network architecture, comprising receiving a financial-transaction-related message destined for a destination; assessing whether said financial-transaction-related message is compliant with a fundamental message format and, upon assessing that said financial-transaction-related message is not compliant with the fundamental message format, effecting a translation of said financial-transaction-related message into a translated message that is compliant with the fundamental message format. The method further comprises releasing said translated message into a network towards said destination. Moreover, the method is characterized in that the translation is performed without requiring knowledge of whether the fundamental message format is employed by the destination.

According to a fourth broad aspect, the present invention seeks to provide a computer-readable medium comprising computer-readable program code which, when interpreted by a computing apparatus, causes the computing apparatus to execute a method for electronic communication of financial-transaction-related messages. The computer-readable program code comprises first computer-readable program code for causing the computing apparatus to receive a financial-transaction-related message destined for a destination; second computer-readable program code for causing the computing apparatus to assess whether the financial-transaction-related message is compliant with a fundamental message format; and third computer-readable program code for causing the computing apparatus to respond to an assessment that said financial-transaction-related message is not compliant with the fundamental message format by (a) effecting a translation of said financial-transaction-related message into a translated message that is compliant with the fundamental message format; and (b) releasing said translated message into a network towards said destination, said translation being performed without requiring knowledge of whether the fundamental message format is employed by the destination.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows an architecture for electronic communication of financial-transaction-related messages among members of a financial community, in accordance with a non-limiting embodiment of the present invention;

FIG. 2 is a block diagram of a first member of the financial community;

FIG. 3 is a block diagram of a second member of the financial community;

FIG. 4A is a message flow diagram showing message flow from the first member of the financial community to the second member of the financial community, in accordance with a first specific non-limiting embodiment of the present invention; and

FIG. 4B is a message flow diagram showing message flow from the first member of the financial community to the second member of the financial community, in accordance with a second specific non-limiting embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

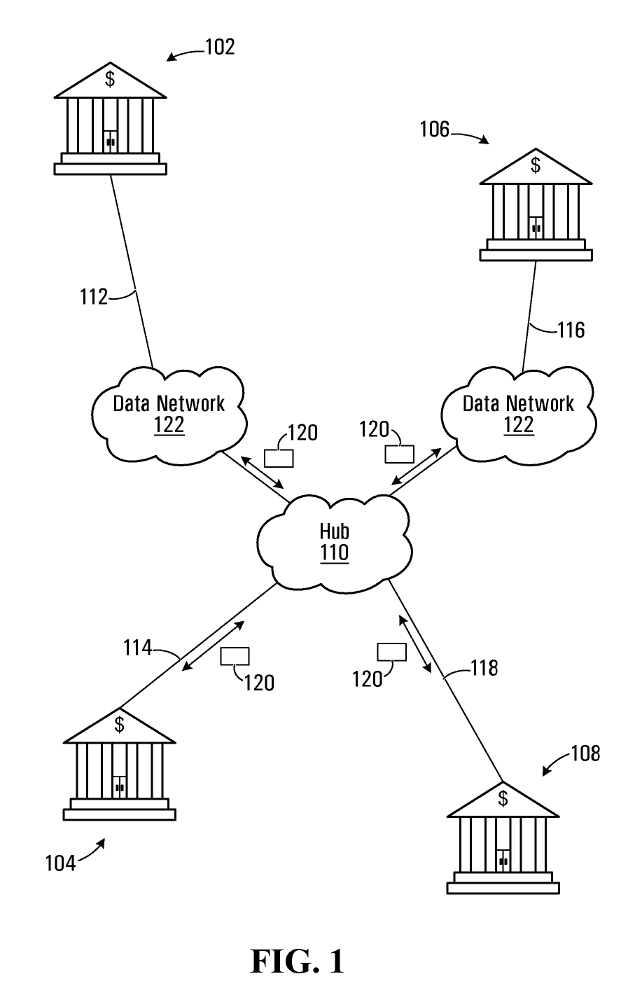

With reference to FIG. 1, there is shown an architecture for electronic communication of financial-transaction-related messages among members 102, 104, 106, 108 of a financial community. The members 102, 104, 106, 108 of the financial community can be of various types, including institutional asset holders (e.g., pension plans), investment brokers and custodians. The financial-transaction-related messages pertain to orders, executions, allocations, affirmations, confirmations, matchings, assignments, novations, etc. between two or more of the aforesaid institutional asset holders, brokers and custodians. (It should be appreciated that the actual exchange of securities for funds is a separate transaction effected over, say, a stock exchange (not shown)—possibly by one or more of the members 102, 104, 106, 108 of the financial community. Processes for effecting such an exchange of securities for funds will be known to those of skill in the art and are not discussed here.)

The members 102, 104, 106, 108 of the financial community, which may be located in geographically disparate regions, are interconnected to one another via a hub 110. Specifically, respective communication links 112, 114, 116, 118 connect the various members 102, 104, 106, 108 of the financial community to the hub 110. The communication links 112, 114, 116, 118 are not particularly limited and, as such, may take the form of wired, wireless and/or optical links, for example. Certain ones of the communication links (in the case of FIG. 1, communication links 112, 116) may traverse one or more data networks 122 (or portions thereof) that can include a public data network (e.g., the Internet) and/or a private data network (e.g., a wired or wireless LAN). Other ones of the communication links (in the case of FIG. 1, communication links 114, 118) may directly connect the respective members (in the case of FIG. 1, members 104, 108) of the financial community to the hub 110.

In order to effect financial transactions, the members 102, 104, 106, 108 of the financial community have the ability to exchange financial-transaction-related messages 120 with each other. The financial-transaction-related messages 120 pass through the hub 110 as they travel from a given one of the members 102, 104, 106, 108 of the financial community to another. To facilitate routing via the hub 110, the financial-transaction-related messages 120 are compliant with a fundamental message format. Conversely, the capabilities of the hub 110 dictate the message format that the financial-transaction-related messages 120 can acquire. Examples of a fundamental message format include, without limitation: FIX 4.1, FIX 4.2, FIX 4.3 and FIX 4.4, to name a few. Other existing or conceivable examples of message formats used in financial transactions can be employed as the fundamental message format without detracting from the spirit of the invention.

The hub 110, which can be a server, a server farm or any other computing entity or arrangement of hardware, software and/or control logic, performs minimal processing of the financial-transaction-related messages 120. Such processing may include, without limitation: storing, forwarding and/or performing error detection/correction to ensure each message's integrity. However, the hub 110 is not required to translate or validate individual ones of the financial-transaction-related messages 120 as they travel between members 102, 104, 106, 108 of the financial community. This allows the financial-transaction-related messages 120 to be efficiently and correctly routed by the hub 110 even though they may carry data which, due to encryption, cannot be read by an entity (e.g., telecommunications service provider) that controls the hub 110.

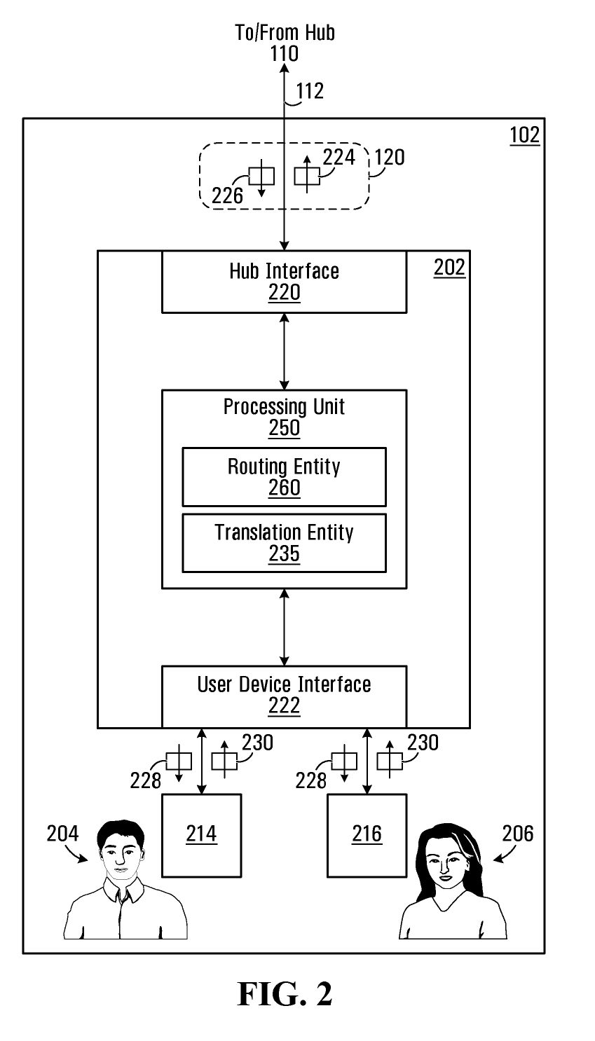

Details regarding one particular member of the financial community (namely, the member 102 of the financial community) are now provided with reference to FIG. 2. Specifically, the member 102 of the financial community comprises a financial management system 202 that is communicatively coupled to the hub 110 via the communication link 112. In some embodiments the financial management system 202 corresponding to the member 102 of the financial community can be embodied as a single server, whereas in other embodiments it can be distributed amongst a plurality of computing entities.

The financial management system 202 supports one or more users (in this case, users 204, 206) associated with the member 102 of the financial community. The users 204, 206 may fall into different categories, depending on the nature of the member 102 of the financial community. Thus, for example, where the member 102 of the financial community is an institutional asset holder, the categories into which the users 204, 206 may fall include, without limitation, portfolio managers and traders. Alternatively, where the member 102 of the financial community is an investment broker, the categories into which the users 204, 206 may fall include, without limitation, traders and institution desk representatives. The users 204, 206 are associated with respective user devices 214, 216, examples of which include desktop computers, laptop computers, tablet PCs, wireless communication devices, personal digital assistants and smart phones, to name a few. In certain embodiments, certain ones (or all) of the user devices 214, 216 can be legacy devices, meaning that they can remain unchanged even while the rest of the financial management system 202 is upgraded with the features described herein.

The financial management system 202 comprises a hub interface 220, a user device interface 222 and a processing unit 250. The hub interface 220 comprises suitable circuitry, software and/or control logic for releasing financial-transaction-related messages 224 towards the hub 110 along the respective communication link 112. The financial-transaction-related messages 224 may be encrypted by the hub interface 220 before being released towards the hub 110. The hub interface 220 also comprises suitable circuitry, software and/or control logic for ensuring that financial-transaction-related messages 226 received from the hub 110 along the respective communication link 112 satisfy low level requirements and are indeed destined for the member 102 of the financial community. In addition, decryption of the financial-transaction-related messages 226 received from the hub 110 may be performed by the hub interface 220. The user device interface 222 comprises suitable circuitry, software and/or control logic for releasing financial-transaction-related messages 228 towards the user devices 214, 216. The financial-transaction-related messages 228 may be encrypted by the user device interface 222 before being released towards the user devices 214, 216. The user device interface 222 also comprises suitable circuitry, software and/or control logic for ensuring that financial-transaction-related messages 230 received from the user devices 214, 216 satisfy low level requirements. In addition, decryption of the financial-transaction-related messages 228 received from the user devices 214, 216 may be performed by the user device interface 222.

Each of the received financial-transaction-related messages 226, 230 is in a message format that depends on where the message in question comes from. Thus, the financial-transaction-related messages 230 received from a given one of the user devices 214, 216 may be compliant with a message format that is specific to the given one of the devices 214, 216, whereas the financial-transaction-related messages 226 received from the hub 110 are compliant with the fundamental message format. It should be noted that in some cases, the message format that is specific to a given one of the devices 214, 216 may actually be the fundamental message format.

Similarly, each of the released financial-transaction-related messages 224, 228 is in a message format that depends on where the message in question is going. Thus, the financial-transaction-related messages 228 released towards a given one of the user devices 214, 216 may be compliant with a message format that is specific to the given one of the user devices 214, 216, whereas the financial-transaction-related messages 224 released towards the hub 110 are compliant with the fundamental message format. Again, it should be noted that in some cases, the message format that is specific to a given one of the devices 214, 216 may actually be the fundamental message format.

The processing unit 250 is connected to the hub interface 220 and to the user device interface 222. The processing unit 250 comprises suitable circuitry, software and/or control logic for receiving the aforementioned financial-transaction-related messages 226, 230 from the hub interface 220 and from the user device interface 222, respectively. The processing unit 250 also comprises suitable circuitry, software and/or control logic for releasing the aforementioned financial-transaction-related messages 224, 228 to the hub interface 220 and to the user device interface 222, respectively.

Recognizing that different financial-transaction-related messages may have different destinations, the processing unit 250 comprises a routing entity 260 operative to make a determination as to where to send a financial-transaction-related message that has been received from either the hub interface 220 or the user device interface 222. Specifically, the routing entity 260 is configured to determine whether a given one of the financial-transaction-related messages 226 received from the hub interface 220 is destined for one of the user devices 214, 216 and, if so, for which one. Similarly, the routing entity 260 is configured to determine whether a given one of the financial-transaction-related messages 230 received from the user device interface 222 is destined for one of the user devices 214, 216 (and, if so, for which one) or needs to be sent to the hub 110. This determination can be made for a particular financial-transaction-related message based on the content of the particular financial-transaction-related message.

Also, recognizing that the message format that is specific to the given one of the user devices 214, 216 may be different from the fundamental message format, the processing unit 250 comprises a translation entity 235 that can be invoked when required or desired. The translation entity 235 is operative to translate financial-transaction-related messages from a given message format into the fundamental message format, or from the fundamental message format to a specified message format.

For example, it may be useful to invoke the translation entity 235 in instances where the routing entity 260 determines that:
CASE T1: a given one of the financial-transaction-related messages 226 received from the hub interface 220 (and compliant with the fundamental message format) is destined for one of the user devices 214, 216, where the destination user device is not adapted to receive financial-transaction-related messages that are compliant with the fundamental message format;
CASE T2: a given one of the financial-transaction-related messages 230 received from the user device interface 222 (and compliant with a user-specific format that different from the fundamental message format) needs to be sent to the hub 110; and
CASE T3: a given one of the financial-transaction-related messages 230 received from the user device interface 222 needs to be sent to a different one of the user devices 214, 216 via the user device interface 222, where the two user devices 214, 216 require respective financial-transaction-related messages to be compliant with different message formats.

Conversely, the translation entity 235 might not need to be invoked in instances where the routing entity 260 determines that:
CASE N1: a given one of the financial-transaction-related messages 226 received from the hub interface 220 (and compliant with the fundamental message format) is destined for one of the user devices 214, 216, where the destination user device is adapted to receive financial-transaction-related messages that are compliant with the fundamental message format;
CASE N2: a given one of the financial-transaction-related messages 230 received from the user device interface 222 (and which happens to be compliant with the fundamental message format) needs to be sent to the hub 110; and
CASE N3: a given one of the financial-transaction-related messages 230 received from the user device interface 222 needs to be sent a different one of the user devices 214, 216 via the user device interface 222, where the two user devices 214, 216 send and receive financial-transaction-related messages that are compliant with the same message formats.

It should be noted that although the above cases may seem to suggest that the routing entity 260 determines the destination of a given financial-transaction-related message prior to invoking the translation entity 235 (where needed), it should be expressly understood that it is within the scope of the invention to invoke the translation entity 235 automatically for all received financial-transaction-related messages that are not compliant with the fundamental message format. In such cases, the routing entity 260 may be configured to operate only on financial-transaction-related messages that are compliant with the fundamental message format, even if this means that the translation entity 235 may need to be invoked twice for the same message (e.g., in the case where a given financial-transaction-related message is received from user device 214 and is destined for user device 216, when both user devices 214, 216 employ a common message format different from the fundamental message format).

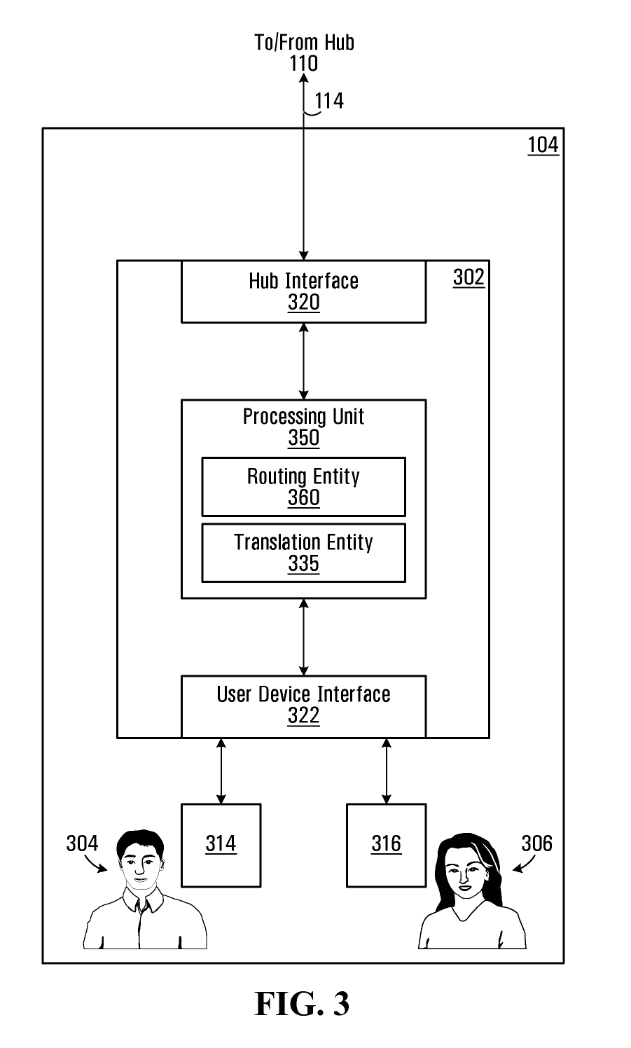

In an analogous fashion, and as shown in FIG. 3, the member 104 of the financial community comprises a respective financial management system 302 that is connected to the hub 110 via the respective one of the communication links (in this case, communication link 114). The financial management system 302 supports one or more users (in this case, users 304, 306) associated with the respective member 104 of the financial community. The users 304, 306 are associated with respective user devices 314, 316. The financial management system 302 comprises a hub interface 320, as well as a user device interface 322 and a processing unit 350. The processing includes a translation entity 335 and a routing entity 360.

It should be appreciated that the translation entity 235 and the routing entity 260 (in FIG. 2) may be implemented as separate hardware or software components or integrated into a common hardware or software entity. Similarly, the translation entity 335 and the routing entity 360 (in FIG. 3) may be implemented as separate hardware or software components or integrated into a common hardware or software entity. If implemented using software, the software may comprise computer-readable program code that includes computer-readable program code for executing various steps in a method for electronic communication of financial-transaction-related messages. Moreover, either or both the processing unit 250 (in FIG. 2) and the processing unit 350 (in FIG. 3) may comprise functional entities in addition to those mentioned above. An example of such a functional entity is a validation entity for detecting fatal errors and/or impossible data entries in a financial-transaction-related message without necessarily being able to gauge the information content of the message.

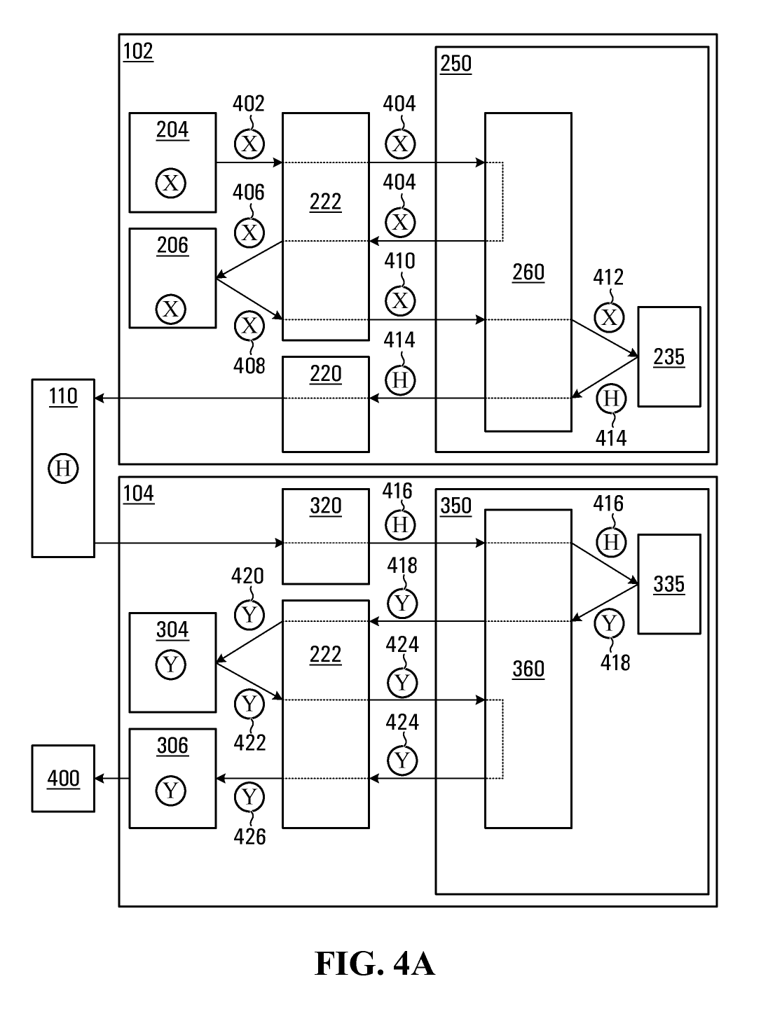

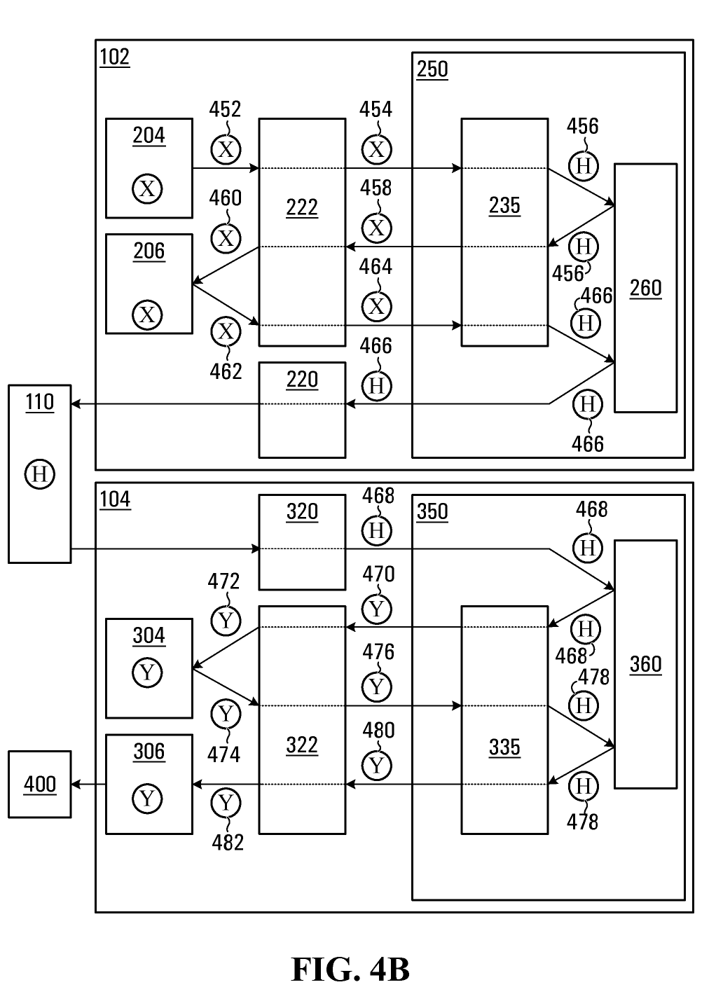

Reference is now made to FIGS. 4A and 4B, each of which illustrates a flow of financial-transaction-related messages in accordance with a respective non-limiting embodiment of the present invention For the purposes of the present discussion, it will be assumed that the financial-transaction-related messages in question pertain to a financial transaction involving the members 102 and 104 of the financial community, where the member 102 is assumed to be an institutional asset holder and the member 104 is assumed to be an investment broker that effects financial transactions on behalf of the institutional asset holder 102. Also, the user 204 associated with the institutional asset holder 102 is assumed to be a portfolio manager, the user 206 associated with the institutional asset holder 102 is assumed to be a trader, the user 304 associated with the investment broker 108 is assumed to be an institution desk representative and the user 306 associated with the investment broker 108 is assumed to be a trader.

Let the financial transaction in the present example comprise an order to trade (i.e., either buy or sell) shares, currencies, etc., hereinafter referred to as a “trade order”. To this end, the trader 306 can be further connected to a trading system 400, via which an executing party (not shown) to the trade can be reached. Generally speaking, the trade order flows from the institutional asset holder 102 to the investment broker 104 to the trading system 400, resulting in the exchange with the executing party of funds for shares or vice versa, thereby executing the trade order.

In support of execution of the trade order, various financial-transaction-related messages are exchanged, as will now be described. For the purposes of the present example, it is assumed that the portfolio manager 204 and the trader 206 exchange financial-transaction-related messages with the financial management system 202 of the institutional asset holder 102 using a message format “X”. Suitable examples of message format X include, without limitation: FIX 4.1, FIX 4.2, FIX 4.3 and FIX 4.4, to name a few. Also for the purposes of the present discussion, it is assumed that the institution desk representative 304 and the trader 306 exchange financial-transaction-related messages with the financial management system 302 of the investment broker 104 using a message format “Y”. Suitable examples of the message format Y include, without limitation: FIX 4.1, FIX 4.2, FIX 4.3 and FIX 4.4, to name a few.

Embodiments of the present invention are particularly useful when at least one of message format X and message format Y is different from the fundamental message format (denoted “H”). In the examples to follow, it is assumed that both message format X and message format Y are different from the fundamental message format H. FIGS. 4A and 4B will now be described separately.
FIG. 4A: routing entity 260 understands message format X; routing entity 360 understands both message format Y and the fundamental message format H

Initially, the portfolio manager 204 formulates the trade order with the intent of sending it to the trader 206 for review. (In a simplified example, the portfolio manager 204 could send the trade order directly to a destination at the investment broker 104). The portfolio manager 204 formulates a financial-transaction-related message 402 compliant with message format X and conveying the trade order. The financial-transaction-related message 402 is received by the user device interface 222. The user device interface 222 determines if the financial-transaction-related message 402 satisfies low level requirements and decrypts it if necessary. If the financial-transaction-related message 402 does not satisfy low level requirements or is not successfully decrypted, the user device interface 222 may return an error message to the portfolio manager 204. However, assuming that the financial-transaction-related message 402 does satisfy low level requirements and is successfully decrypted into a decrypted financial-transaction-related message 404, the decrypted financial-transaction-related message 404 is provided to processing unit 250, which invokes the routing entity 260.

The routing entity 260, which in this embodiment is assumed to understand message format X, determines that the decrypted financial-transaction-related message 404 is destined for the trader 206 and, moreover, determines that the trader 206 also employs message format X. Thus, the routing entity 260 sends the decrypted financial-transaction-related message 404 to the trader 206 via the user device interface 222 without the need for invoking the translation entity 235. The user device interface 222 may re-encrypt the decrypted financial-transaction-related message 404 into a financial-transaction-related message 406 prior to releasing it to the trader 206. The trader 206 then reviews the trade order contained in the financial-transaction-related message 406 and can annotate it with the intent of sending an annotated trade order to the institution desk representative 304 associated with the investment broker 104. Specifically, the trader 206 formulates a financial-transaction-related message 408 compliant with message format X and conveying the annotated trade order. The financial-transaction-related message 408 is received by the user device interface 222. The user device interface 222 determines if the financial-transaction-related message 408 satisfies low level requirements and decrypts it if necessary. If the financial-transaction-related message 408 does not satisfy low level requirements or is not successfully decrypted, the user device interface 222 may return an error message to the trader 206. However, assuming that the financial-transaction-related message 408 does satisfy low level requirements and is successfully decrypted into a decrypted financial-transaction-related message 412, the decrypted financial-transaction-related message 412 is provided to the processing unit 250, which invokes the routing entity 260.

The routing entity 260, which has already been assumed to understand message format X, determines that the decrypted financial-transaction-related message 412 needs to be sent over the hub 110. However, the processing unit 250 realizes that the decrypted financial-transaction-related message 412 is not compliant with the fundamental message format H. Therefore, the processing unit 250 invokes the translation entity 235, which translates the decrypted financial-transaction-related message 412 into a translated financial-transaction-related message 414 that is compliant with the fundamental message format H. It should be appreciated that by virtue of the translation process, the translated financial-transaction-related message 414 may carry less information than the financial-transaction-related message 408 formulated by the trader 206. This can arise in situations where the fundamental message format H does not support certain options available in message format X. However, one can keep the loss of information to a minimum by using a fundamental message format H that is at least as versatile as message format X.

If the translation process encounters problems (e.g., due to the message format of the decrypted financial-transaction-related message 412 being obsolete), then such problems can be signaled to the trader 206 via the user device interface 222 in an attempt to correct the problems. If the problems cannot be rectified, the translation entity 235 may simply cause the trade order to be aborted. On the other hand, if the problems can be rectified, or if there was no problem with translation to begin with, the processing unit 250 causes the release of the translated financial-transaction-related message 414 (conveying the annotated trade order) to the hub 110 via the hub interface 220. The hub interface 220 may also encrypt the translated financial-transaction-related message 414 prior to transmission to the hub 110.

The hub 110 ensures that the translated financial-transaction-related message 414 conveying the annotated trade order reaches the investment broker 104. This may involve routing the translated financial-transaction-related message 414 over one or more data networks. It is noted that the translated financial-transaction-related message 414 is and remains compliant with the fundamental message format H throughout its journey from the institutional asset holder 102 to the investment broker 104 via the hub 110.

The translated financial-transaction-related message 414 conveying the annotated trade order is received at the financial management system 302 associated with the investment broker 104. More specifically, the hub interface 320 receives the translated financial-transaction-related message 414, determines if it satisfies low level requirements, decrypts it if necessary, and determines that it is in fact destined for the investment broker 104. If the translated financial-transaction-related message 414 does not satisfy low level requirements or is not successfully decrypted, the hub interface 320 may return an error message to the institutional asset holder 102. However, in this example, the translated financial-transaction-related message 414 is indeed destined for the investment broker 104 and is assumed to be successfully decrypted into a decrypted financial-transaction-related message 416, which is provided to the processing unit 350, which invokes the routing entity 360.

The routing entity 360, which in this embodiment is assumed to understand the fundamental message format H (as well as message format Y), determines that the decrypted financial-transaction-related message 416 is destined for the trader 206. However, the processing unit 350 realizes that the institution desk representative 304 employs message format Y. Therefore, the processing unit 350 invokes the translation entity 335, which translates the decrypted financial-transaction-related message 416 into a translated financial-transaction-related message 418 that is compliant with message format Y. It should be appreciated that by virtue of the translation process, the translated financial-transaction-related message 418 may carry less information than the translated financial-transaction-related message 414 received from the hub 110. This can arise in situations where message format Y does not support certain options available in the fundamental message format H. However, one can keep the loss of information to a minimum by using message format Y that is at least as versatile as the fundamental message format H.

If the translation process encounters problems (e.g., due to the message format of the decrypted financial-transaction-related message 416 being obsolete), then such problems can be signaled to the institutional asset holder 102 via the hub interface 320 in an attempt to correct the problems. If the problems cannot be rectified, the translation entity 335 may simply cause the trade order to be aborted. On the other hand, if the problems can be rectified, or if there was no problem with translation to begin with, the processing unit 350 causes the release of the translated financial-transaction-related message 418 (conveying the annotated trade order) to the institution desk representative 304 via the user device interface 322. The user device interface 322 may also re-encrypt the translated financial-transaction-related message 418 into an encrypted financial-transaction-related message 420 prior to transmission to the institution desk representative 304.

The institution desk representative 304 then “clears” the annotated trade order contained in the encrypted financial-transaction-related message 420 with the intent of sending it to the trader 306. Specifically, the institution desk representative 304 formulates a financial-transaction-related message 422 compliant with message format Y and conveying a cleared trade order. The financial-transaction-related message 422 is received by the user device interface 322. The user device interface 322 determines if the financial-transaction-related message 422 satisfies low level requirements and decrypts it if necessary. If the financial-transaction-related message 422 does not satisfy low level requirements or is not successfully decrypted, the user device interface 322 may return an error message to the institution desk representative 304. However, assuming that the financial-transaction-related message 422 does satisfy low level requirements and is successfully decrypted, a decrypted financial-transaction-related message 424 is provided to the processing unit 350, which invokes the routing entity 360.

The routing entity 360, which in this embodiment is assumed to understand message format Y (as well as the fundamental message format H, as mentioned earlier), determines that the decrypted financial-transaction-related message 424 (conveying the cleared trade order) is destined for the trader 306 and, moreover, determines that the trader 306 also employs message format Y. Thus, the routing entity 360 sends the decrypted financial-transaction-related message 424 (conveying the cleared trade order) to the trader 306 via the user device interface 322 without the need for invoking the translation entity 335. The user device interface 322 may re-encrypt the decrypted financial-transaction-related message 424 into a financial-transaction-related message 426 prior to releasing it to the trader 306.

Upon receipt of the financial-transaction-related message 426 conveying the cleared trade order, the trader 306 sends the cleared trade order into the trading system 400, where the cleared trade order is executed. The trading system 400 may be accessible to the trader 306 either directly or via the financial management system 302. Once the cleared trade order is filled, or as it progresses, the financial management system 302 can be provisioned to return an “execution report” to the portfolio manager 204 via the hub 110.

Persons skilled in the art will therefore appreciate that neither the portfolio manager 204 nor the trader 206 needs to have any knowledge of message format Y employed by the institution desk representative 304 and the trader 306 when creating the financial-transaction-related messages 402, 408. In addition, neither the translation entity 235 nor any other element of the financial management system 202 needs to have any knowledge of message format Y when formulating, for example, the financial-transaction-related message 414. Moreover, neither the translation entity 335 nor any other element of the financial management system 302 needs to have any knowledge of message format X when receiving, for example, the financial-transaction-related message 416. In addition, neither the institution desk representative 304 nor the trader 306 needs to have any knowledge of message format X employed by the portfolio manager 204 and the trader 206 when receiving the financial-transaction-related messages 420, 426.

Thus, the institutional asset holder 102 can participate in financial transactions with the investment broker 104 (or any other member 106, 108 of the financial community) without having to concern itself with the message format employed by the investment broker 104 (or such other member), and vice versa. This is made possible by equipping each financial management system 202, 302 with a translation entity 235, 335. As such, by not requiring that the message format employed by a given member of the financial community be known by any other member, the architecture is rendered flexible and scalable. Meanwhile, by using a fundamental message format for communications between the financial management systems 202, 302 and the hub 110, the routing of financial-transaction-related messages to the appropriate destination is rendered more efficient.
FIG. 4B: routing entities 260, 360 understand only the fundamental message format H

Initially, the portfolio manager 204 formulates the trade order with the intent of sending it to the trader 206 for review. (In a simplified example, the portfolio manager 204 could send the trade order directly to a destination at the investment broker 104). The portfolio manager 204 formulates a financial-transaction-related message 452 compliant with message format X and conveying the trade order. The financial-transaction-related message 452 is received by the user device interface 222. The user device interface 222 determines if the financial-transaction-related message 452 satisfies low level requirements and decrypts it if necessary. If the financial-transaction-related message 452 does not satisfy low level requirements or is not successfully decrypted, the user device interface 222 may return an error message to the portfolio manager 204. However, assuming that the financial-transaction-related message 452 does satisfy low level requirements and is successfully decrypted into a decrypted financial-transaction-related message 404, the decrypted financial-transaction-related message 454 is provided to the processing unit 250.

The processing unit 250 first determines the message format with which the decrypted financial-transaction-related message 454 is compliant (in this case, message format X). In a non-limiting example, this can be achieved directly by inspection of the decrypted financial-transaction-related message 454 or indirectly, based on knowledge of the message origin (in this case, the portfolio manager 204). Then, the processing unit 250 invokes the translation entity 235, which translates the decrypted financial-transaction-related message 454 into a translated financial-transaction-related message 456 that is compliant with the fundamental message format H.

It should be appreciated that by virtue of the translation process, the translated financial-transaction-related message 456 may carry less information than the financial-transaction-related message 452 formulated by the portfolio manager 204. This can arise in situations where the fundamental message format H does not support certain options available in message format X. However, one can keep the loss of information to a minimum by using a fundamental message format H that is at least as versatile as message format X.

If the translation process encounters problems (e.g., due to the message format of the decrypted financial-transaction-related message 454 being obsolete), then such problems can be signaled to the portfolio manager 204 via the user device interface 222 in an attempt to correct the problems. If the problems cannot be rectified, the translation entity 235 may simply cause the trade order to be aborted. On the other hand, if the problems can be rectified, or if there was no problem with translation to begin with, the processing unit 250 invokes the routing entity 260.

The routing entity 260, which in this example is assumed to understand the fundamental message format H, determines that the translated financial-transaction-related message 456 is destined for the trader 206.

At this point, based on the fact that the translated financial-transaction-related message 456 is destined for the trader 206, the processing unit 250 determines that translation of the translated financial-transaction-related message 456 will be required in order to render it compliant with message format X. Accordingly, the processing unit 250 invokes the translation entity 235, which translates the translated financial-transaction-related message 456 into a re-translated financial-transaction-related message 458 that is compliant with message format X.

The processing unit 250 then causes the release of the re-translated financial-transaction-related message 458 to the trader 206 via the user device interface 222. The user device interface 222 may re-encrypt the re-translated financial-transaction-related message 458 into a financial-transaction-related message 460 prior to releasing it to the trader 206.

The trader 206 then reviews the trade order contained in the financial-transaction-related message 460 and can annotate it with the intent of sending an annotated trade order to the institution desk representative 304 associated with the investment broker 104. Specifically, the trader 206 formulates a financial-transaction-related message 462 compliant with message format X and conveying the annotated trade order. The financial-transaction-related message 462 is received by the user device interface 222. The user device interface 222 determines if the financial-transaction-related message 462 satisfies low level requirements and decrypts it if necessary. If the financial-transaction-related message 462 does not satisfy low level requirements or is not successfully decrypted, the user device interface 222 may return an error message to the trader 206. However, assuming that the financial-transaction-related message 462 does satisfy low level requirements and is successfully decrypted into a decrypted financial-transaction-related message 464, the decrypted financial-transaction-related message 464 is provided to the processing unit 250.

The processing unit 250 first determines the message format with which the decrypted financial-transaction-related message 464 is compliant (in this case, message format X). In a non-limiting example, this can be achieved directly by inspection of the decrypted financial-transaction-related message 464 or indirectly, based on knowledge of the message origin (in this case, the trader 206). Then, the processing unit 250 invokes the translation entity 235, which translates the decrypted financial-transaction-related message 464 into a translated financial-transaction-related message 466 that is compliant with the fundamental message format H.

If the translation process encounters problems (e.g., due to the message format of the decrypted financial-transaction-related message 464 being obsolete), then such problems can be signaled to the trader 206 via the user device interface 222 in an attempt to correct the problems. If the problems cannot be rectified, the translation entity 235 may simply cause the trade order to be aborted. On the other hand, if the problems can be rectified, or if there was no problem with translation to begin with, the processing unit 250 invokes the routing entity 260.

The routing entity 260 determines that the translated financial-transaction-related message 466 needs to be sent over the hub 110. Since the translated financial-transaction-related message 466 is already compliant with the fundamental message format H, there is no need to re-invoke the translation entity 235. The routing entity 260 thus releases the translated financial-transaction-related message 466 (conveying the annotated trade order) to the hub 110 via the hub interface 220. The hub interface 220 may also encrypt the translated financial-transaction-related message 466 prior to transmission to the hub 110.

The hub 110 ensures that the translated financial-transaction-related message 466 conveying the annotated trade order reaches the investment broker 104. This may involve routing the translated financial-transaction-related message 466 over one or more data networks. It is noted that the translated financial-transaction-related message 466 is and remains compliant with the fundamental message format H throughout its journey from the institutional asset holder 102 to the investment broker 104 via the hub 110.

The translated financial-transaction-related message 466 conveying the annotated trade order is received at the financial management system 302 associated with the investment broker 104. More specifically, the hub interface 320 receives the translated financial-transaction-related message 466, determines if it satisfies low level requirements, decrypts it if necessary, and determines that it is in fact destined for the investment broker 104. If the translated financial-transaction-related message 466 does not satisfy low level requirements or is not successfully decrypted, the hub interface 320 may return an error message to the institutional asset holder 102. However, in this example, the translated financial-transaction-related message 466 is indeed destined for the investment broker 104 and is assumed to be successfully decrypted into a decrypted financial-transaction-related message 468, which is provided to the processing unit 350.

Since the decrypted financial-transaction-related message 468 arrives from the hub 110, it is known to be in the fundamental message format H and, as such, the processing unit 350 need not invoke the translation entity 335. Instead, the processing unit 350 invokes the routing entity 360. The routing entity 360, which in this embodiment is assumed to understand the fundamental message format H, determines that the decrypted financial-transaction-related message 468 is destined for the institution desk representative 304.

At this point, based on the fact that the decrypted financial-transaction-related message 468 is destined for the institution desk representative 304, the processing unit 350 determines that translation of the decrypted financial-transaction-related message 468 will be required in order to render it compliant with message format Y. Accordingly, the processing unit 350 invokes the translation entity 335, which translates the decrypted financial-transaction-related message 468 into a translated financial-transaction-related message 470 that is compliant with message format Y.

It should be appreciated that by virtue of the translation process, the translated financial-transaction-related message 470 may carry less information than the translated financial-transaction-related message 466 received from the hub 110. This can arise in situations where message format Y does not support certain options available in the fundamental message format H. However, one can keep the loss of information to a minimum by using message format Y that is at least as versatile as the fundamental message format H.

If the translation process encounters problems (e.g., due to the message format of the decrypted financial-transaction-related message 468 being obsolete), then such problems can be signaled to the institutional asset holder 102 via the hub interface 320 in an attempt to correct the problems. If the problems cannot be rectified, the translation entity 335 may simply cause the trade order to be aborted. On the other hand, if the problems can be rectified, or if there was no problem with translation to begin with, the processing unit 350 causes the release of the translated financial-transaction-related message 470 (conveying the annotated trade order) to the institution desk representative 304 via the user device interface 322. The user device interface 322 may also re-encrypt the translated financial-transaction-related message 470 into an encrypted financial-transaction-related message 472 prior to transmission to the institution desk representative 304.

The institution desk representative 304 then “clears” the annotated trade order contained in the encrypted financial-transaction-related message 472 with the intent of sending it to the trader 306. Specifically, the institution desk representative 304 formulates a financial-transaction-related message 474 compliant with message format Y and conveying a cleared trade order. The financial-transaction-related message 474 is received by the user device interface 322. The user device interface 322 determines if the financial-transaction-related message 474 satisfies low level requirements and decrypts it if necessary. If the financial-transaction-related message 474 does not satisfy low level requirements or is not successfully decrypted, the user device interface 322 may return an error message to the institution desk representative 304. However, assuming that the financial-transaction-related message 474 does satisfy low level requirements and is successfully decrypted, a decrypted financial-transaction-related message 476 is provided to processing unit 350.

The processing unit 350 first determines the message format with which the decrypted financial-transaction-related message 476 is compliant (in this case, message format Y). In a non-limiting example, this can be achieved directly by inspection of the decrypted financial-transaction-related message 476 or indirectly, based on knowledge of the message origin (in this case, the institution desk representative 304). Then, the processing unit 350 invokes the translation entity 335, which translates the decrypted financial-transaction-related message 476 into a translated financial-transaction-related message 478 that is compliant with the fundamental message format H.

If the translation process encounters problems (e.g., due to the message format of the decrypted financial-transaction-related message 476 being obsolete), then such problems can be signaled to the institution desk representative 304 via the user device interface 322 in an attempt to correct the problems. If the problems cannot be rectified, the translation entity 335 may simply cause the trade order to be aborted. On the other hand, if the problems can be rectified, or if there was no problem with translation to begin with, the processing unit 350 invokes the routing entity 360.

The routing entity 360, which in this example is assumed to understand the fundamental message format H, determines that the translated financial-transaction-related message 478 is destined for the trader 306.

At this point, based on the fact that the translated financial-transaction-related message 478 is destined for the trader 306, the processing unit 350 determines that re-translation of the translated financial-transaction-related message 478 will be required in order to render it compliant with message format Y. Accordingly, the processing unit 350 invokes the translation entity 335, which translates the translated financial-transaction-related message 478 into a re-translated financial-transaction-related message 480 that is compliant with message format Y. The processing unit 350 then causes the release of the re-translated financial-transaction-related message 480 to the trader 306 via the user device interface 222. The user device interface 222 may re-encrypt the re-translated financial-transaction-related message 480 into a financial-transaction-related message 482 prior to releasing it to the trader 306.

Upon receipt of the financial-transaction-related message 482 conveying the cleared trade order, the trader 306 sends the cleared trade order into the trading system 400, where the cleared trade order is executed. The trading system 400 may be accessible to the trader 306 either directly or via the financial management system 302. Once the cleared trade order is filled, or as it progresses, the financial management system 302 can be provisioned to return an “execution report” to the portfolio manager 204 via the hub 110.

Again, persons skilled in the art will appreciate that neither the portfolio manager 204 nor the trader 206 needs to have any knowledge of message format Y employed by the institution desk representative 304 and the trader 306 when creating the financial-transaction-related messages 452, 462. In addition, neither the translation entity 235 nor any other element of the financial management system 202 needs to have any knowledge of message format Y when formulating, for example, the financial-transaction-related message 466. Moreover, neither the translation entity 335 nor any other element of the financial management system 302 needs to have any knowledge of message format X when receiving, for example, the financial-transaction-related message 468. In addition, neither the institution desk representative 304 nor the trader 306 needs to have any knowledge of message format X employed by the portfolio manager 204 and the trader 206 when receiving the financial-transaction-related messages 472, 482.

Thus, the institutional asset holder 102 can participate in financial transactions with the investment broker 104 (or any other member 106, 108 of the financial community) without having to concern itself with the message format employed by the investment broker 104 (or such other member). This is made possible by equipping each financial management system 202, 302 with a translation entity 235, 335. As such, by not requiring that the message format employed by a given member of the financial community be known by any other member, the architecture is rendered flexible and scalable. Meanwhile, by using a fundamental message format for communications between the financial management systems 202, 302 and the hub 110, the routing of financial-transaction-related messages to the appropriate destination is rendered more efficient.

Persons skilled in the art will appreciate that in an alternative embodiments, the hub 110 can be omitted from the architecture for electronic communication of financial-transaction-related messages without departing from the spirit of the invention. Specifically, peer-to-peer communication links (similar to the communication links 112, 114, 116, 118) can be established between pairs of members 102, 104, 106, 108 of the financial community. In order to effect financial transactions in this alternative hub-less (or “peer-to-peer”) architecture, the members 102, 104, 106, 108 of the financial community have the ability to exchange financial-transaction-related messages 120 with each other directly.

To maximize flexibility of the ability of the members 102, 104, 106, 108 of the financial community to communicate with one another in this alternative peer-to-peer architecture, the financial-transaction-related messages 120 are compliant with a fundamental message format that can be the same as, or different from, the previously described fundamental message format that was used in the financial network architecture of FIG. 1 that contained the hub 110.

Also, in this alternative peer-to-peer architecture, the hub interfaces 220, 320 previously described with reference to the financial management systems 202, 302 in FIGS. 2 and 3 are replaced by respective external interfaces which comprise suitable circuitry, software and/or control logic for sending and receiving financial-transaction-related messages 120 over the respective communication link 112, 114. While specific embodiments of the present invention have been described and illustrated, it will be apparent to those skilled in the art that numerous modifications and variations can be made without departing from the scope of the invention as defined in the appended claims.

1. A method for electronic communication of financial-transaction-related messages in a financial network architecture, comprising:
at a first functional entity, receiving a financial-transaction-related message destined for a destination associated with a second functional entity;
assessing whether said financial-transaction-related message is compliant with a fundamental message format;
upon assessing that said financial-transaction-related message is not compliant with the fundamental message format:
effecting a translation of said financial-transaction-related message into a translated message that is compliant with the fundamental message format;
releasing said translated message towards said destination;
receiving the translated message at the second functional entity;
assessing whether said translated message is compliant with a message format that is employed by the destination;
upon assessing that said translated message is not compliant with a message format that is employed by the destination:
effecting a translation of said translated message into a re-translated message that is compliant with a message format that is employed by the destination.

2. The method defined in claim 1, wherein said releasing said translated message towards said destination is effected over a communications network.

3. (canceled)

4. (canceled)

5. (canceled)

6. The method defined in claim 1, wherein assessing whether said financial-transaction-related message is compliant with a fundamental message format comprises determining a format with which said financial-transaction-related message is compliant.

7. The method defined in claim 6, wherein said determining a format with which said financial-transaction-related message is compliant comprises inspecting said financial-transaction-related message.

8. The method defined in claim 6, wherein said determining a format with which said financial-transaction-related message is compliant comprises identifying a device that originates said financial-transaction-related message.

9. The method defined in claim 8, wherein said determining a format with which said financial-transaction-related message is compliant further comprises consulting a database that associates devices to message formats.

10. The method defined in claim 2, further comprising:
processing said translated message at a hub located in said communications network.

11. The method defined in claim 1, wherein said fundamental message format comprises FIX 4.1, FIX 4.2, FIX 4.3 and FIX 4.4.

12. The method defined in claim 1, wherein upon receipt at said first functional entity, said financial-transaction-related message is in a message format that is the same as the message format employed by the destination.

13. The method defined in claim 1, wherein at least one of the first and second functional entities comprises an institutional asset holder, a trader, an investment broker or a custodian.

14. (canceled)

15. (canceled)

16. (canceled)

17. (canceled)

18. (canceled)

19. The method defined in claim 1, further comprising:
releasing the re-translated message towards the destination.

20. (canceled)

21. The method defined in claim 19, further comprising:
at the second functional entity, determining that the translated message is destined for said destination prior to said releasing the re-translated message towards the destination.

22. The method defined in claim 21, wherein said determining that the translated message is destined for the destination is effected prior to effecting said translation of said translated message into said re-translated message.

23. The method defined in claim 21, wherein said determining that the translated message is destined for said destination is effected after effecting said translation of said translated message into said re-translated message.

24. The method defined in claim 1, wherein assessing whether said translated message is compliant with a message format that is employed by the destination comprises determining the message format employed by the destination.

25. The method defined in claim 24, wherein said determining the message format employed by the destination comprises consulting a database that associates destinations to message formats.

26. (canceled)

27. (canceled)

28. The method defined in claim 1, wherein the first functional entity is the second functional entity.

29. An architecture for electronic communication of financial-transaction-related messages, comprising:
a first financial management system configured to receive a financial-transaction-related message destined for a destination associated with a second financial management system, said first financial management system being further configured to assess whether said financial-transaction-related message is compliant with a fundamental message format and, upon assessing that said financial-transaction-related message is not compliant with the fundamental message format, to effect a translation of said financial-transaction-related message into a translated message that is compliant with the fundamental message format, said first financial management system further configured to release said translated message;
a hub configured to route said translated message from said first financial management system to said second financial management system;
said second financial management system configured to receive the translated message at the second financial management system, to assess whether said translated message is compliant with a message format that is employed by the destination and, upon assessing that said translated message is not compliant with a message format that is employed by the destination, to effect a translation of said translated message into a re-translated message that is compliant with a message format that is employed by the destination.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A computer-readable medium comprising computer-readable program code which, when interpreted by a computing apparatus, causes the computing apparatus to execute a method for electronic communication of financial-transaction-related messages, the computer-readable program code comprising:
first computer-readable program code for causing the computing apparatus to receive a financial-transaction-related message destined for a destination;
second computer-readable program code for causing the computing apparatus to assess whether the financial-transaction-related message is compliant with a fundamental message format;
third computer-readable program code for causing the computing apparatus to respond to an assessment that said financial-transaction-related message is not compliant with the fundamental message format by:
effecting a translation of said financial-transaction-related message into a translated message that is compliant with the fundamental message format;
releasing said translated message into a network towards said destination;
said translation being performed without requiring knowledge of whether the fundamental message format is employed by the destination.

43. (canceled)

44. (canceled)

45. (canceled)

46. (canceled)

47. (canceled)

48. (canceled)

49. The method defined in claim 1, wherein the financial-transaction-related messages include one or more orders, executions, allocations, affirmations, confirmations, matchings, assignments and/or novations between two or more entities from the group comprising institutional asset holders, brokers and custodians.

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)
